(19) United States
(12) Patent Application Publication
(10) Pub. No.: US 2018/0251377 A1
(43) Pub. Date: Sep. 6, 2018

(54) AEROGELS

(71) Applicant: The University of Manchester, Manchester (GB)

(72) Inventors: Brian DERBY, Manchester (GB); Ian KINLOCH, Manchester (GB); Mark BISSETT, Manchester (GB); Gabriel CASANO CARNICER, Manchester (GB); Yue LIN, Manchester (GB)

(21) Appl. No.: 15/760,052

(22) PCT Filed: Oct. 7, 2016
(86) PCT No.: PCT/GB2016/053123

§ 371 Date: Mar. 14, 2018

(30) Foreign Application Priority Data
Oct. 8, 2015 (GB) 1517795.9

(51) Int. Cl. C01B 32/194; C01B 21/064; B01J 13/00; H01M 4/62; B01J 21/18; B01J 27/24; B01J 35/00; B01J 37/04; B01J 37/02; B01J 37/03; H01G 11/36; H01G 11/24; H01G 11/86; F16L 59/02

(52) U.S. Cl. CPC C01B 32/194; H01B 1/04; B01J 13/0091; H01M 4/625; B01J 21/18; B01J 27/24; B01J 35/0013; B01J 37/04; B01J 37/0236; B01J 37/038; H01G 11/36; H01G 11/24; H01G 11/86; F16L 59/028; C01P 2004/03; C01P 2004/02; C01B 2204/22; C01P 2004/24; C01P 2006/14; C01B 21/0648

(57) ABSTRACT

The invention relates to aerogels of two-dimensional materials such as graphene. This invention particularly relates to methods of making said aerogels by room temperature freeze casting (RTFC).

This invention relates to aerogels formed from flakes of two-dimensional materials. The aerogels are formed by room temperature freeze casting (RTFC).

### BACKGROUND

Since its isolation in 2004 by Geim and Novosolev, Graphene has excited considerable attention as a material with novel properties derived from its 2D structure. Graphene has applications in technologies as diverse as composites, electronics, sensing, catalysis, membranes and energy storage. Graphene and graphene derived materials are strong candidate materials for anodes in Li batteries; they are also believed to be ideal materials, because of their very high specific surface area, for electrodes in double layer supercapacitors. Both these technologies are key enablers for a transition from a fossil fuel dominated energy market, to those based on renewables and nuclear energy, where significant electrical energy storage is needed for load levelling and transport applications.

The isolation of graphene has led to the identification of many other two-dimensional crystals through exfoliation of suitable layered compounds. These materials are all molecular and are typically compounds formed from a single element or 2, 3, 4 or 5 different elements. Compounds which have been isolated as single- or few layer platelets or crystals include hexagonal boron nitride and transition metal dichalcogenides (e.g. NbSe₂ and MoS₂). These single or few layer platelets or crystals are stable and can exhibit complementary electronic properties to graphene, such as being insulators, semiconductors and superconductors.

For many applications of graphene, notably in the area of supercapacitors, batteries and catalysis, graphene must be available in a highly porous 3D configuration to maximise the available surface area. Aerogels are nanomaterials with high levels of porosity and specific surface area.

The highest surface area to volume ratio in a graphene aerogel is obtained using chemical vapour deposition (CVD) to grow single or few layer graphene on nanoporous templates (Chen, Z. P. et al. Three-dimensional flexible and conductive interconnected graphene networks grown by chemical vapour deposition. Nat Mater 10, 424-428 (2011)). The method requires the manufacture of a nanoporous template prior to graphene deposition, followed by dissolution of the template to leave the aerogel. Although this produces the highest quality material, high production costs are likely to limit the range of the materials' applicability.

The second method for aerogel manufacture begins with dispersion of exfoliated graphene oxide (GO) flakes. GO has a high density of oxidised surface functionalisation, making it relatively easy to process in aqueous suspension. The first step is to gel the dispersion, which can be achieved chemically, e.g. polymerization of resorcinol and formaldehyde in an aqueous suspension of graphene oxide, followed by solvent removal through exchange with liquid CO₂ and critical point drying (Worsley, M. A. et al. Synthesis of Graphene Aerogel with High Electrical Conductivity. Journal of the American Chemical Society, 132, 2010 14067-14069). The resulting GO aerogel is then thermally reduced to form a more conductive reduced graphene oxide (RGO) aerogel. An alternative route gels the GO aqueous suspension through liquid phase reduction, which leads to flake/flake adhesion and a more conductive RGO aerogel after solvent removal, omitting the final thermal treatment (Zhang, X. T. et al. Mechanically strong and highly conductive graphene aerogel and its use as electrodes for electrochemical power sources. Journal of Materials Chemistry, 21, 2001, 6494-6497).

In a further method rapid cooling of the aqueous suspension to <−40° C. to promote freeze gelation (freeze casting) has been used (Qiu, L., Liu, J. Z., Chang, S. L. Y., Wu, Y. & Li, D. Biomimetic superelastic graphene-based cellular monoliths. Nature Communications, 3, 2012). In order to convert the gelled sol to an aerogel, the frozen water must be removed. This drying step must not result in a liquid vapour interface, otherwise capillary forces will destroy the low density, high surface area aerogel. In the case of a gel formed via chemical crosslinking, water is removed by solvent exchange and supercritical drying with CO₂; whereas after freeze gelation, ice is removed by sublimation (freeze drying).

However, producing graphene aerogels by conventional freeze casting has a number of limitations as a manufacturing process. The process as used in the current state of the art requires an aqueous suspension of GO as the starting material and this limits the quality and conductivity of the graphene aerogel which can be obtained after a reduction step. Reduced graphene oxide typically retains a significant oxygen content and a higher proportion of carbons are sp³ hybridised than in pristine graphene, meaning that there is a high defect content in the resulting aerogel.

Further, the process requires cooling to −40° C. or lower temperatures to produce a suitably microcrystalline ice and this can limit the size and shape of an object that can be processed.

Thirdly, the frozen intermediate stage before solvent removal is brittle and difficult to process, thus most freeze processed graphene is produced as a nanoporous powder for subsequent secondary processing to form a device.

### BRIEF SUMMARY OF THE DISCLOSURE

In a first aspect of the invention there is provided a method for preparing an aerogel of a two-dimensional material; the method comprising:
a) providing a suspension of flakes of the two-dimensional material in a solvent or solvent mixture;
b) reducing the temperature of the suspension to below the melting temperature of the solvent or solvent mixture to form a solid suspension; and
c) allowing or enabling the solvent to sublime from the solid suspension to provide the aerogel of a two-dimensional material;
   wherein the solvent or solvent mixture has a melting point at 1 atm in the range from 20 to 300° C. and a vapour pressure at 25° C. in the range from 0.0001 to 2 kPa.

The solvent may have a vapour pressure such that a cubic cm of the solid will sublime completely in 24 hours when held at 10° C. below its melting temperature in air at 1 atm pressure.

The inventors have found that aerogels of graphene and other two-dimensional materials can be formed by room temperature freeze casting from suitable solvents. The resulting graphene aerogels are of a better quality and exhibit higher conductivity than those generated from the reduction of graphene oxide aerogels described in the prior art. The process is easier and cheaper than CVD techniques of making high quality graphene aerogels. Room temperature freeze casting uses less energy, is safer and more convenient, and can offer more control over, e.g. pore size of the product aerogel, than traditional freeze casting methods.

Without wishing to be bound by theory, it is believed that the gelation of the suspension is driven by the pushing together of the flakes of two-dimensional material by the growing solid/liquid interface. The final aerogels will have two levels of porosity: a nanoscale porosity determined by the frustrated packing of the graphene flakes and a microscale porosity controlled by the crystal size in the solidified solvent. The scale of the microporosity can be controlled by varying the solidification rate with the microstructural scale growing smaller as the cooling rate increases.

It may be that the suspension of the two-dimensional material in the solvent or solvent mixture also comprises a polymer or that it also comprises a monomer or oligomer that can be subsequently polymerised or cross-linked in solution. It may be that the suspension of the two-dimensional material in the solvent also comprises a monomer or oligomer that can be subsequently polymerised or cross-linked in solution. It may be that the suspension of the two-dimensional material in the solvent also comprises a polymer. The polymer, monomer or oligomer may be dissolved in the solvent or it may be suspended in the solvent, either as a solid or as a liquid (i.e. an emulsion). The polymer may be selected from: polyvinylidene fluoride (PVDF), polystyrene (PS), polyvinylalcohol (PVA), poly(methyl methacrylate) (PMMA), polypropylene (PP), polyethylene (PE), polyamide (PA, Nylon), polyacetonitrile (PAN), poly(sodium 4-styrensulfonate) (PSS). In certain preferred embodiments, the polymer is selected from: polystyrene, polyacetonitrile and polyvinylalcohol. In certain preferred embodiments, the polymer is selected from: polyacetonitrile and polyvinylalcohol. The polymer may be present in an amount from 0.1% to 80% by volume relative to the amount of the two-dimensional material. The polymer may be present in an amount from 0.1% to 10% (e.g. from 1% to 10%) by volume relative to the amount of the two-dimensional material. In these embodiments, the polymer acts as a binder that increases the stability of the product two-dimensional material aerogel. The polymer can also influence the structure of the product aerogel, allowing the structure to be tailored to the specific requirements of any given application. The polymer may be present in an amount from 10% to 50% by volume relative to the amount of the two-dimensional material. In these embodiments, the product of the process is a composite aerogel. The polymer may be present in an amount from 50% to 80% by volume relative to the amount of the two-dimensional material. In these embodiments, the product of the process is a polymer aerogel with improved properties due to the presence of the two-dimensional material, e.g. improved electrical conductivity or structural strength. The polymer may be present in an amount from 0.1% to 50% (e.g. from 1% to 40%) by weight relative to the amount of the two-dimensional material. The polymer may be present in an amount from 5% to 30% by weight relative to the amount of the two-dimensional material.

Where the two-dimensional material is graphene, the suspension and the product aerogel will typically comprise a polymer.

Where the suspension comprises a polymer, the suspension may also comprise a surfactant.

Where the two-dimensional material in the solvent also comprises a monomer or oligomer that can be subsequently polymerised or cross-linked in solution, the method typically comprises the step of causing the monomer or oligomer to polymerise or to cross-link. This step may occur before the solvent is solidified or it may occur once the solvent has been solidified.

The solvent or solvent mixture in which the two-dimensional material is suspended will be in the form of a liquid, i.e. it will be at a temperature above the melting point of the solvent or solvent mixture.

The step of providing the suspension may comprise suspending flakes of the two-dimensional material in a solvent or solvent mixture to form the suspension. This occurs at a temperature above the melting point of the solvent or solvent mixture. For the absence of doubt, the solvent or suspension which is used to make the suspension is the same as that which is solidified to form the solid suspension. Typically, no solvent is added or removed between the step of forming the suspension and step b) above.

Where the suspension also comprises a polymer, a monomer or an oligomer that can be subsequently polymerised or cross-linked, the solvent or solvent mixture in which the two-dimensional material is suspended may comprise a polymer, a monomer or an oligomer that can be subsequently polymerised or cross-linked. Alternatively, it may be that the polymer or the monomer or the oligomer that can be subsequently polymerised or cross-linked is added to the suspension of the two-dimensional material in the solvent or solvent mixture.

The suspension will typically be a homogenous suspension. The amount of the two-dimensional material in the suspension may be from 0.001 to 100 mg/mL. Very low concentrations of the two-dimensional material are tolerated. It is believed that as the solvent solidifies, the flakes of the two-dimensional material are pushed to and by the solid/liquid interface meaning that in the solid suspension, the flakes are predominantly situated at the crystal boundaries, thus achieving local concentrations of the flakes that are very high compared to the starting concentration of the flakes in the suspension. Thus, depending on the rate of cooling and the solvent or solvent mixture in question, concentrations of below 0.001 mg/mL may be tolerated. The amount of the two-dimensional material in the suspension may be from 0.1 to 10 mg/mL.

The step of suspending flakes of the two-dimensional material in the solvent or solvent mixture to form a suspension may comprise the steps of:

adding flakes of the two-dimensional material to the solvent or solvent mixture; and

applying energy to the mixture to form the suspension (e.g. homogenous suspension) of two-dimensional flakes in the solvent or solvent mixture.

The application of energy to the mixture may be achieved by sonication. The application of energy to the mixture may be achieved by stirring. It may be a mixture of sonicating and stirring. It may be achieved by shear mixing. It may be achieved by ball milling, e.g. planetary ball milling. It may be achieved by attrition milling.

The step of suspending flakes of the two-dimensional material in the solvent or solvent mixture to form a suspension may comprise the steps of:

adding flakes of a bulk layered material to the solvent or solvent mixture; and

applying energy to the mixture to form the suspension (e.g. homogenous suspension) of two-dimensional flakes in the solvent or solvent mixture. The application of energy to the mixture may be achieved by sonication. The application of energy to the mixture may be achieved by stirring. It may be a mixture of sonicating and stirring. It may be achieved by shear mixing. It may be achieved by ball milling, e.g. planetary ball milling. It may be achieved by attrition milling. This is particularly effective where the solvent is phenol. The resultant suspension may have to be centrifuged to remove any residual layered material.

The solvent or solvent mixture will typically be capable of maintaining the two-dimensional material (e.g. graphene) in a homogenous suspension. It may be capable of maintaining the two-dimensional material (e.g. graphene) in a homogenous suspension for 24 hours. It may have a Hansen parameter for dispersion (δ_{D}) in the range from 15 to 25 MPam^{1/2}, a Hansen parameter for polarisation (δ_{P}) in the range from 1 to 20 MPam^{1/2} and a Hansen parameter for hydrogen bonding (δ_{H}) in the range from 0.1 to 15 MPam^{1/2}. δ_{D} may be in the range from 16 to 21 MPam^{1/2}, e.g. from 17 to 19 MPam^{1/2}. δ_{P} may be in the range from 3 to 12 MPam^{1/2}, e.g. from 6 to 11 MPam^{1/2}. δ_{H} may be in the range from 0.2 to 11 MPam^{1/2}, e.g. from 5 to 9 MPam^{1/2}. The Hansen parameters can be calculated as described in ‘Solubility Parameters” A. F. M. Barton, Chemical Reviews, 75 p 731-753 (1975) and “Hansen Solubility Parameters: A users handbook” C. M. Hansen, CRC Press (2007) ISBN 13:978-1-4200-0683-4.

Unlike suspensions of two-dimensional materials (e.g. graphene) in water, suspensions in the solvents or solvent mixtures of the invention do not typically need to include surfactants to provide a stable suspension. The present invention may thus avoid the need to remove surfactants from the product aerogel once it has been prepared.

The solvent or solvent in which the two-dimensional materials are suspended are typically organic. It may be that they form plastically deformable solids below their melting point.

The solvent or solvent mixture may have a melting point at 1 atm in the range from 25 to 200° C. The solvent or solvent mixture may have a melting point at 1 atm in the range from 30 to 100° C. The solvent or solvent mixture may have a melting point at 1 atm in the range from 40 to 80° C.

The solvent or solvent mixture may have a vapour pressure at 25° C. in the range from 0.001 to 1 kPa. The solvent or solvent mixture may have a vapour pressure at 25° C. in the range from 0.01 to 0.5 kPa. The solvent or solvent mixture may have a vapour pressure at 25° C. in the range from 0.02 to 0.1 kPa.

The solvent or the main component of the solvent mixture may have a molecular weight in the range from 75 to 200, e.g. from 80 to 175.

The solvent or at least one component of the solvent mixture be selected from: camphene, camphor, naphthalene, succinonitrile, phenol, tert-butanol, anthracene, cinnamic acid, benzoic acid, resorcinol. In certain preferred embodiments, the solvent or at least one component of the solvent mixture is selected from camphene, camphor, naphthalene, succinonitrile, phenol and tert-butanol. It may be that more than one component of the solvent mixture is selected from: camphene, camphor, naphthalene, succinonitrile, phenol. The solvent or at least one component of the solvent mixture be selected from: camphene, camphor, naphthalene, succinonitrile, phenol, tert-butanol, anthracene, cinnamic acid, benzoic acid, resorcinol and menthol. In certain preferred embodiments, the solvent or at least one component of the solvent mixture is selected from camphene, camphor, naphthalene, succinonitrile, phenol, tert-butanol and menthol. It may be that more than one component of the solvent mixture is selected from: camphene, camphor, naphthalene, phenol and menthol. The solvent or at least one component of the solvent mixture be selected from: camphene, naphthalene, succinonitrile, phenol, tert-butanol, anthracene, cinnamic acid, benzoic acid, resorcinol and menthol. In certain preferred embodiments, the solvent or at least one component of the solvent mixture is selected from camphene, naphthalene, succinonitrile, phenol, tert-butanol and menthol. The solvent may be menthol. The solvent may be naphthalene. An example of a solvent comprising two components is a mixture of camphor and naphthalene.

The two-dimensional materials may be suspended in a pure or substantially pure (i.e. greater than 90 weight % or greater than 95 weight %) pure solvent. For the absence of doubt, the solvent is not water. Likewise, the solvent is not DMSO.

The two-dimensional materials may be suspended in a mixture of two or more solvents. If this is the case, it will typically be the case that the composition of the solvent mixture will be such that at some composition the mixed solvents have a melting point at 1 atm in the range from 1 to 300° C. and a vapour pressure above the solid phase at 25° C. in the range from 0.0001 to 2 kPa. This may be the case even if one of the solvents in the mixture does not have these properties in its pure form. Where this is the case, it may be that the solvent that does not have these properties is present in an amount less than 50 weight %, e.g. less than 10 weight % or less than 5 weight %. Thus, the solvent may comprise water but typically this will be in an amount less than 10 weight %, e.g. less than 5 weight %. It may be that each of the components of the mixture has a melting point at 1 atm in the range from 1 to 300° C. and a vapour pressure at 25° C. in the range from 0.0001 to 2 kPa.

In certain embodiments of the invention the components of the solvent mixture are such that they undergo eutectic solidification. Eutectic mixtures solidify at lower temperature than their constituent components. They typically form characteristic lamellar microstructures on solidification and this can result in a finer scale solid microstructure than is the case with conventional solidification. For example camphor-naphthalene (melting points of 175 and 79° C. respectively) has a eutectic melting temperature of 40° C., and camphor-succinonitrile (melting points of 175 and 55° C. respectively) close to 30° C. If mixed solvents are used with eutectic solidification there can be a larger number of interfaces present in the solidified structures including dendrite/liquid interfaces with hypo- and hypereutectic compositions as well as the complex 3-phase growth front at the eutectic temperature. At high growth rates it is possible that the eutectic interlaminar spacing may approach graphene flake dimensions. In other embodiments of the invention the solvent mixture is such that they undergo monotectic solidification.

It may be that the solvent mixture in which the two-dimensional material is suspended comprises at least one low boiling point solvent, e.g. at least one solvent with a boiling point below 100° C. or below 80° C. Examples include hexane, ethanol, propanol, chloroform, diethylether, dichloromethane. Where this is the case, the process may include the step of allowing or enabling the evaporation of the low boiling point solvent. This will typically occur before the temperature of the suspension is lowered.

It may be that the solvent mixture comprises only solvents that have a melting point at 1 atm in the range from 20 to 300° C. and a vapour pressure at 25° C. in the range from 0.0001 to 2 kPa. It may be that the solvent mixture comprises greater than 90% by weight (e.g. greater than 95 weight % or greater than 98 weight %) solvents that have a melting point at 1 atm in the range from 20 to 300° C. and a vapour pressure at 25° C. in the range from 0.0001 to 2 kPa. The solvent mixture may not comprise DMF. The solvent mixture may comprise no more than 1 weight % by weight DMF or no more than 0.1 weight % by weight DMF.

The suspension typically takes the form of a viscous fluid. It may be that the suspension is formed into a pattern before the temperature is reduced. Thus, the method may comprise the step of printing the suspension before reducing the temperature, e.g. printing the suspension to form a pattern. The method may also comprise the step of die casting the suspension before reducing the temperature. In this way, the aerogels produced in the methods of the invention may be formed in a desired form (e.g. shape, size or pattern). The method may also comprise the step of extruding the viscous fluid prior to freezing to provide an uniform section rod, tube or filament. The method may also comprise the viscous fluid being spread onto a substrate by a doctor blade or by slot die casting to form a uniform coating before reducing the temperature. These processes can be facilitated by including a low boiling point solvent in the solvent mixture as described in the previous paragraph. Once the pattern has been formed the step of allowing or enabling the evaporation of the low boiling point solvent can be carried out.

The step of reducing the temperature of the suspension may comprise simply allowing the mixture to cool, e.g. to room temperature or to below the melting point of the solvent. The step of reducing the temperature of the suspension to below the melting temperature of the solvent may comprise placing the suspension in a coolant selected from: liquid nitrogen, a mixture of solid CO₂ and a suitable solvent (e.g. ethanol, acetone) and a mixture of water and ice. The step of reducing the temperature may comprise placing the suspension in a refrigerator, freezer or blast chiller. The step of reducing the temperature may involve the use of one or more cold fingers (see for example Deville et al. Science, 311, 2006, 515-518) or Peltier coolers. Said cold fingers or Peltier coolers could be placed into the suspension.

In many of the embodiments of the invention, the solid product of step b) is a low melting temperature waxy solid. This wax solid can be plastically deformed and can thus undergo secondary processing including: injection moulding, calendaring, extrusion and 3D printing. This allows the aerogel which is produced in the method of the invention to be produced in the desired form (e.g. shape, size or pattern). The process may thus comprise the step of shaping the solid into a desired form before the sublimation step.

It may be that the solid suspension is pelletised to form pellets of the solid suspension. The pellets may be reformed into the desired form (e.g. shape, size or pattern).

The step of allowing or enabling the solvent to sublime from the solid suspension may comprise leaving the solid at room temperature and atmospheric pressure. It may comprise placing the solid suspension under low pressure, e.g. using a pump or rotary evaporation. It may also involve holding the solid to a temperature below its melting temperature at the local pressure (e.g. a temperature in a range from a temperature 10° C. below the melting temperature at the local pressure and the melting point).

The two-dimensional material may be selected from graphene, functionalised graphene, h-BN, a transition metal dichalcogen, phosphorene and a layered group IV-group VI compound and mixtures thereof.

In certain preferred embodiments, the two-dimensional material is graphene. Thus, it may be graphene which contains less than 10 weight % oxygen, e.g. less than 5 weight % oxygen or less than 1 weight % oxygen. The oxygen content of graphene is dependent on the oxygen content of the graphite from which it is prepared. Some natural graphite has an oxygen content of up to about 5% but most graphite has an oxygen content of less than about 2%. Reduced graphene oxide, on the other hand typically has an oxygen content of greater than 15%. The graphene may be pristine graphene. Alternatively, it may have been functionalised, e.g. oxidised, in such a way as to improve the efficiency of the process or the properties of the product aerogel. Where the graphene has been previously modified it may be that the carbon content is 90 wt % or greater, e.g. 95 wt % or greater. Thus, even if has previously been oxidised, it may be that the graphene contains less than 10 weight % oxygen, e.g. less than 5 weight % oxygen. The oxygen content of a graphene or oxygenated graphene (e.g. graphene oxide, reduced graphene oxide, partially oxidised graphene oxide) sample can be determined by calculation of the atomic ratio of O to C in sample detected by X-ray photoelectron spectroscopy (XPS) (see Yang et al., Carbon, 47, 2009, 145-152).

It may be that greater than 80%, e.g. greater than 90%, of the carbon in the graphene is sp² hybridised. The relative amounts of sp² and sp^{a} hybridised carbon in a graphene or functionalised graphene (e.g. graphene oxide, reduced graphene oxide, partially oxidised graphene oxide) sample can also be calculated using XPS (see Soikou et al, Applied Surface Science, 257, 2011, 9785-9790 and Yamada et al, Carbon, 70, 2014, 59-74).

The two-dimensional material may be a functionalised graphene, e.g. graphene oxide, reduced graphene oxide, partially oxidised graphene oxide, halographene (e.g. fluorographene), graphane.

The two-dimensional material may be h-BN.

The two-dimensional material may be a transition metal dichalcogen (e.g. MoS₂, WS₂, MoTe₂, MoSe₂, WSe₂, etc.).

The two dimensional material may be phosphorene (i.e. a single or few-layer crystal of black phosphorous).

The two-dimensional material may be a layered group IV-group VI-compound such as SnS, GeS, GeSe or SnSe.

The two-dimensional material may be a mixture of two two-dimensional materials. The two dimensional material may be a mixture selected MoS₂/WS₂ and MoS₂/graphene.

It may be that the flakes of two-dimensional material (e.g. graphene) have an average length for the largest lateral dimension in the range from 10 nm to 200 μm. It may be that the two-dimensional material (e.g. graphene) has an average flake thickness in the range from 1 to 10 molecular layers, e.g. from 1 to 5 molecular layers. Each individual flake may have a range of thicknesses across its breadth and this average is intended to mean the average across all flakes. The flake size can be determined by microscopy, e.g. images obtained by optical microscopy, scanning electron microscopy, transmission electron microscopy or atomic force microscopy (See Khan et al., Carbon, 50, 2012, 470-475). The flake thickness can be obtained by measuring the height of a flake on a substrate using atomic force microscopy (see P. Nemes-Incze et al., Carbon, 46, 2008, 1435-1442). The flake thickness can also be determined from characteristic features of the Raman spectrum obtained from a flake.

The suspension, and thus the resulting aerogel, may also comprise carbon nanotubes. Said nanotubes may be functionalised or unfunctionalised and they may be single-walled or multi-walled. The presence of nanotubes can influence the structure of the product aerogel, possibly by preventing the two dimensional material from restacking and aggregating. In certain embodiments, this can provide an improvement in properties of the product aerogel. The nanotubes may be present in an amount from 1% by weight to 50% by weight relative to the amount of two-dimensional material. Thus the suspension, and thus the resulting aerogel, may contain a mixture of graphene and carbon nanotubes. Alternatively, the suspension, and thus the resulting aerogel, may contain a mixture of MoS₂ and carbon nanotubes.

Once formed, the aerogel may be compressed to reduce its porosity.

Once formed, the aerogel may be powdered to form an aerogel powder. It may be that the aerogel powder is subsequently mixed with a polymer (see, for example, the list of polymers mentioned above in relation to the suspension of the two-dimensional materials in the solvent or solvent mixture) and cast into a desired form (e.g. shape, size or pattern).

Once formed, a catalyst or a catalyst precursor may be added to the aerogel to form an aerogel supported catalyst or an aerogel supported catalyst precursor. The catalyst may comprise a transition metal, e.g. a transition metal selected from palladium, rhodium, ruthenium, platinum, nickel, copper, osmium etc. Similar aerogel supported catalysts or aerogel supported catalyst precursors can be formed by including a catalyst or catalyst precursor in the suspension of the two-dimensional material in the solvent or solvent mixture. Where an aerogel supported catalyst precursor is formed, a further process step will typically be required to form the catalytic species.

Where the product aerogel comprises a polymer, it may be preferable in some cases to subsequently carbonise the polymer through heating. This can increase the conductivity of the aerogel.

In a second aspect of the invention is provided an aerogel of a two-dimensional material obtainable by (e.g. obtained by) the methods of the first aspect.

In a third aspect of the invention is provided a graphene aerogel, wherein the graphene is in the form of flakes and wherein the graphene contains less than 10 weight % oxygen and/or greater than 80% of the carbon in the graphene is sp² hybridised.

It may be that the graphene contains less than 5 weight % oxygen. It may be that greater than 90% of the carbon in the graphene is sp² hybridised.

The graphene aerogel may have a conductivity of greater than 2 S/cm.

The graphene aerogel may also comprise a polymer. The polymer may be selected from: polyvinylidene fluoride (PVDF), polystyrene (PS), polyvinylalcohol (PVA), poly(methyl methacrylate) (PMMA), polypropylene (PP), polyethylene (PE), polyamide (PA, Nylon), polyacetonitrile (PAN), poly(sodium 4-styrensulfonate) (PSS). In certain preferred embodiments, the polymer is selected from: polyacetonitrile (PAN) and polyvinylalcohol (PVA). The polymer may be present in an amount from 0.1% to 80% by volume relative to the amount of the graphene. The polymer may be present in an amount from 0.1% to 10% (e.g. from 1% to 10%) by volume relative to the amount of the graphene. In these embodiments, the polymer acts as a binder that increases the stability of the graphene aerogel. The polymer may be present in an amount from 10% to 50% by volume relative to the amount of the graphene. In these embodiments, the graphene aerogel is a graphene/polymer composite aerogel. The polymer may be present in an amount from 50% to 80% by volume relative to the amount of the graphene. In these embodiments, graphene aerogel is a polymer aerogel with improved properties due to the presence of the graphene, e.g. improved electrical conductivity or structural strength.

In a fourth aspect of the invention is provided an aerogel of a two-dimensional material selected from a transition metal dichalcogenide and hBN.

The aerogel may also comprise a second two-dimensional material selected from graphene, a transition metal dichalcogenide and hBN. Where the first two-dimensional material is a transition metal dichalcogenide (e.g. MoS₂), the second two-dimensional material may be a different transition metal dichalcogenide (e.g. WS₂).

Where appropriate, any of the embodiments described above in relation to the first aspect apply also to the third and fourth aspects and vice versa. This is particularly the case for the embodiments relating to the polymer and to the two dimensional material (e.g. graphene).

In a fifth aspect of the invention is provided a product comprising an aerogel of the second, third or fourth aspects.

The product may be an electronic device.

The product may be an electrode. The product may be a device (e.g. a battery or capacitor) comprising said electrode.

The product may be a catalyst system in which the active catalytic agent is supported on the aerogel.

Where the aerogel comprises a transition metal dichalcogenide, the aerogel itself may be a catalyst.

The product may be or may be comprised in an thermal insulator material. The product may be or may be comprised in an electrically conductive thermal insulator material.

In a sixth aspect of the invention is provided a solid suspension comprising flakes of a two-dimensional material (e.g. graphene) distributed throughout a solvent or solvent mixture, the solvent or solvent mixture being in solid form, wherein the solvent or solvent mixture has a melting point at 1 atm in the range from 20 to 300° C. and a vapour pressure at 25° C. in the range from 0.0001 to 2 kPa.

The solid suspension is typically plastically deformable. The solid suspension is typically obtainable by (e.g. obtained by) step b) of the first aspect. The solid suspension may comprise a plurality of crystals, the crystals comprising the solvent, each component of the solvent mixture or a mixture of the components of the solvent mixture; wherein the flakes of two-dimensional material (e.g. graphene) are predominantly situated at the crystal boundaries. The term predominantly is intended to mean that greater than 75 weight % or greater than 90% or greater than 95% of the flakes are situated at the crystal boundaries.

The solid suspension may be wholly or partly comprised of an amorphous material or a material in a glassy state.

The solid suspension may also comprise a polymer.

Where appropriate, any of the embodiments described above in relation to the first aspect apply also to the sixth aspect and vice versa. This is particularly the case for the embodiments relating to the polymer, the solvent and to the two-dimensional material.

### BRIEF DESCRIPTION OF THE DRAWINGS

Embodiments of the invention are further described hereinafter with reference to the accompanying drawings, in which:

FIG. 1 shows the SEM images of microstructure of the PG aerogels (20 mg/cm³) prepared in phenol.

FIG. 2 shows the SEM images of microstructure of the PG aerogels (40 mg/cm³) prepared in phenol.

FIG. 3 shows the SEM images of microstructure of the PG aerogels (20 mg/cm³) prepared in camphene.

FIG. 4 shows the SEM images of microstructure of the PG/multiwalled carbon nanotubes (MWCNT) (weight ratio 4:1, 20 mg/cm³).

FIG. 5 shows the SEM images of microstructure of the PG/PAN (weight ratio: 4:1, 40 mg/cm³).

FIG. 6 shows the SEM images of microstructure of the PG/PVA (weight ratio: 4:1, 40 mg/cm³).

FIG. 7 shows the SEM images of microstructure of the PG/single-walled carbon nanotube (SWCNT) (weight ratio 8.5:1.5, 100 mg/cm³).

FIG. 8 shows graphene 3D objects printed using robotic deposition with (a) single layer deposition, (b) 3 layer deposition, and (c) side view of 3 layer deposition, (d) electrical conductivity of pristine graphene aerogel versus density in comparison with the literature values of several low density carbon nanomaterials (CVD graphene foam, carbon nanotube (CNT) foam, reduced graphene based aerogel, and reduced graphene cellular network) (e) Nitrogen adsorption/desorption curve for PG aerogel (6 mg/cm³) and PG/MWCNT (weight ratio 4:1, 2.5 mg/cm³) (f) Raman Spectra of as prepared PG powder and PG aerogel.

FIG. 9 shows the electrochemical performance of various graphene based aerogels prepared by RTFC (PG aerogel (6 mg/cm³), RGO aerogel (6 mg/cm³), PG/MWCNT (weight ratio 4:1, 2.5 mg/cm³) and RGO/MWCNT (weight ratio 4:1, 2.5 mg/cm³)). a) cyclic voltammetry curves of the aerogels at the scan rate of 10 mV/s, (b) charge/discharge curves of the aerogels at the discharge current density of 1 A/g, (c) specific capacitance of the aerogels as a function of current densities, and (d) cycling test of the aerogels at the current density of 20 A/g up to 10000 cycles.

FIG. 10 shows the differential pore volume distribution of the PG (6 mg/cm³) and PG/MWCNT (weight ratio 4:1, 2.5 mg/cm³)) obtained by Barret-Joyner-Halenda (BJH) method.

FIG. 11 shows cyclic voltammetry curves of the aerogels at various scan rate. (a) PG aerogel (6 mg/cm³), (b) PG/MWCNT (weight ratio 4:1, 2.5 mg/cm³), (c) RGO aerogel (6 mg/cm³), and (d) RGO/MWCNT (weight ratio 4:1, 2.5 mg/cm³).

FIG. 12 shows galvanostatic charge/discharge curves of the aerogels at the various discharge current density. (a) PG aerogel (6 mg/cm³), (b) PG/MWCNT (weight ratio 4:1, 2.5 mg/cm³), (c) RGO aerogel (6 mg/cm³), and (d) RGO/MWCNT (weight ratio 4:1, 2.5 mg/cm³).

FIG. 13 shows the Ragone plot the various aerogel based supercapacitors.

FIG. 14 shows Nyquist plots of the two-electrode supercapacitors based on the various aerogels.

FIG. 15 shows the equivalent circuit model.

FIG. 16 shows SEM images of microstructure of the PG/PVA aerogel (weight ratio: 4:1, 40 mg/cm³) prepared in liquid nitrogen.

FIG. 17 shows SEM images of microstructure of the PG/PAN aerogel (weight ratio: 4:1, 40 mg/cm³) prepared in liquid nitrogen.

### DETAILED DESCRIPTION

Two-dimensional materials are not truly two-dimensional, but they exist in the form of particles which have a thickness that is significantly smaller than their other dimensions. The term ‘two-dimensional’ has become customary in the art.

The term ‘two-dimensional material’ may mean a compound in a form which is so thin that it exhibits different properties than the same compound when in bulk. Not all of the properties of the compound will differ between a few-layered particle and a bulk compound but one or more properties are likely to be different. Typically, two-dimensional compounds are in a form which is single- or few layers thick, i.e. up to 10 molecular layers thick. A two-dimensional crystal of a layered material (e.g. an inorganic compound or graphene) is a single or few layered particle of that material. The terms ‘two-dimensional’ and ‘single or few layered’ are used interchangeably throughout this specification.

The bonding between the layers of a layered material (which may be two-dimensional providing the particles comprise sufficiently few layers) is considerably weaker (typically only Van der Waals forces or π-πinteractions) than the bonding between the atoms within the layers of the layered material (typically covalent bonding).

The term ‘few-layered particle’ may mean a particle which is so thin that it exhibits different properties than the same compound when in bulk. Not all of the properties of the compound will differ between a few-layered particle and a bulk compound but one or more properties are likely to be different. A more convenient definition would be that the term ‘few layered’ refers to a crystal that is from 2 to 9 molecular layers thick (e.g. 2 to 5 layers thick). Crystals of graphene which have more than 9 molecular layers (i.e. 10 atomic layers; 3.5 nm) generally exhibit properties more similar to graphite than to graphene. A molecular layer is the minimum thickness chemically possible for that compound. In the case of hexagonal boron-nitride one molecular layer is a single atom thick. In the case of the transition metal dichalcogenides (e.g. MoS₂ and WS₂), a molecular layer is three atoms thick (one transition metal atom and two chalcogen atoms). Thus, few-layer particles crystals are generally less than 50 nm thick, depending on the compound and are preferably less than 20 nm thick, e.g. less than 10 or 5 nm thick.

A layer of graphene consists of a sheet of sp²-hybridized carbon atoms. Each carbon atom is covalently bonded to three neighboring carbon atoms to form a ‘honeycomb’ network of tessellated hexagons. Carbon nanostructures which have more than 10 graphene layers (i.e. 10 atomic layers; 3.5 nm interlayer distance) generally exhibit properties more similar to graphite than to mono-layer graphene. Thus, throughout this specification, the term graphene is intended to mean a carbon nanostructure with up to 10 graphene layers. Graphene is often referred to as a 2-dimensional structure because it represents a single sheet or layer of carbon of nominal (one atom) thickness. Graphene can be considered to be a single sheet of graphite. Throughout this specification, the term pristine graphene is intended to mean graphene that has not been chemically modified.

Transition metal dichalcogenides (TMDCs) are structured such that each layer of the compound consists of a three atomic planes: a layer of transition metal atoms (for example Mo, Ta, W) sandwiched between two layers of chalcogen atoms (for example S, Se or Te). Thus in one embodiment, the TMDC is a compound of one or more of Mo, Ta and W with one or more of S, Se and Te. There is strong covalent bonding between the atoms within each layer of the transition metal chalcogenide and predominantly weak Van der Waals bonding between adjacent layers. Exemplary TMDCs include NbSe₂, WS₂, MoS₂, TaS₂, PtTe₂, VTe₂.

Phosphorene is structured such that each layer consists of a puckered arrangement of atoms that do not coexist on a single geometric plane but are nonetheless stacked and the stacked layers weakly bound by Van der Waals forces.

The two-dimensional material group IV-group VI compounds also show a puckered layered sheet structure with each sheet containing an equal number of each component of the compound and the stacked layers weakly bound by Van der Waals forces.

An aerogel is a porous solid. It can be characterised as being comprised of a microporous solid in which the dispersed phase is a gas. An ‘aerogel’ is so-called because it is usually made by displacing the liquid in a gel (a gel being a liquid dispersed in a solid) with a gas, although this is not the method described in the present application.

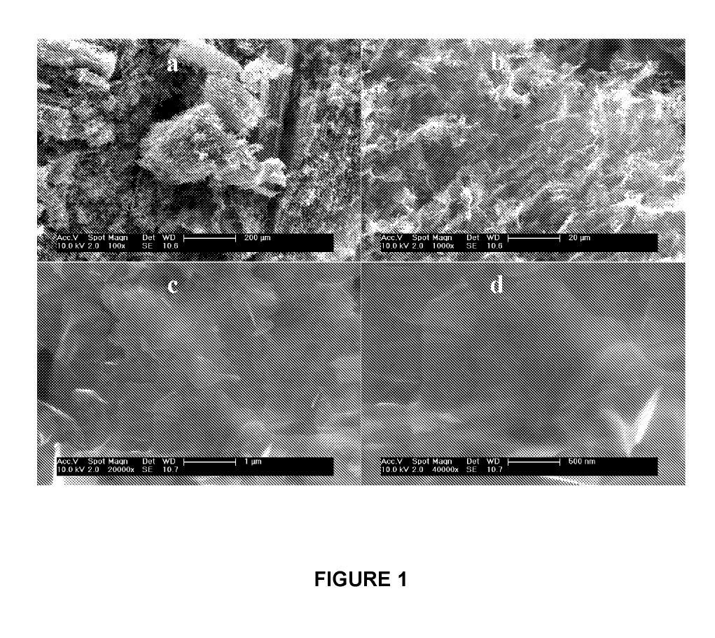

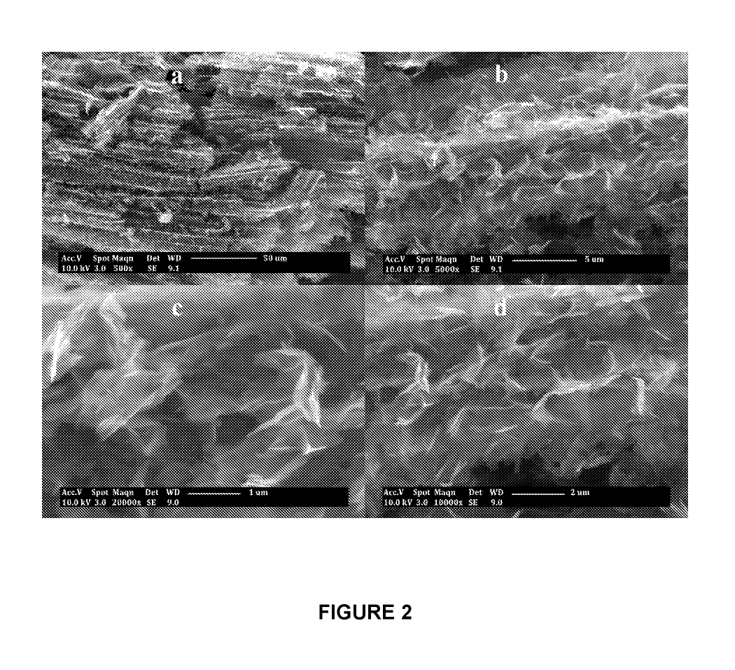

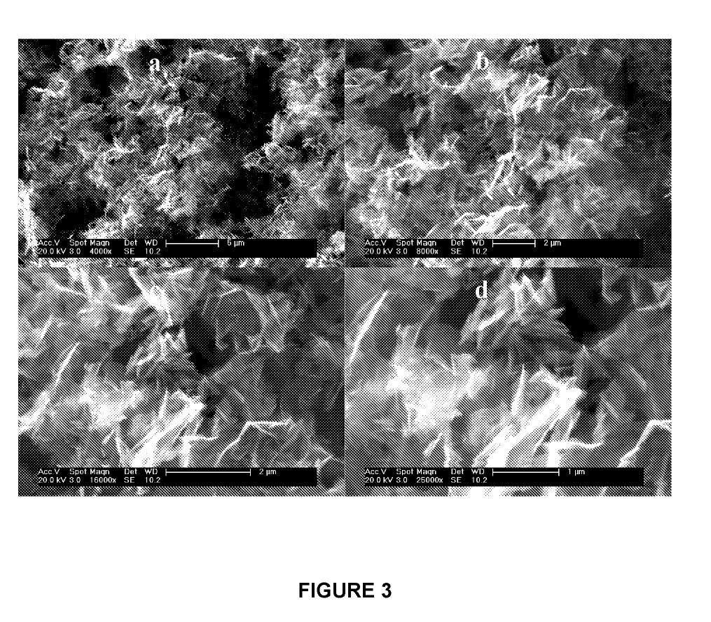

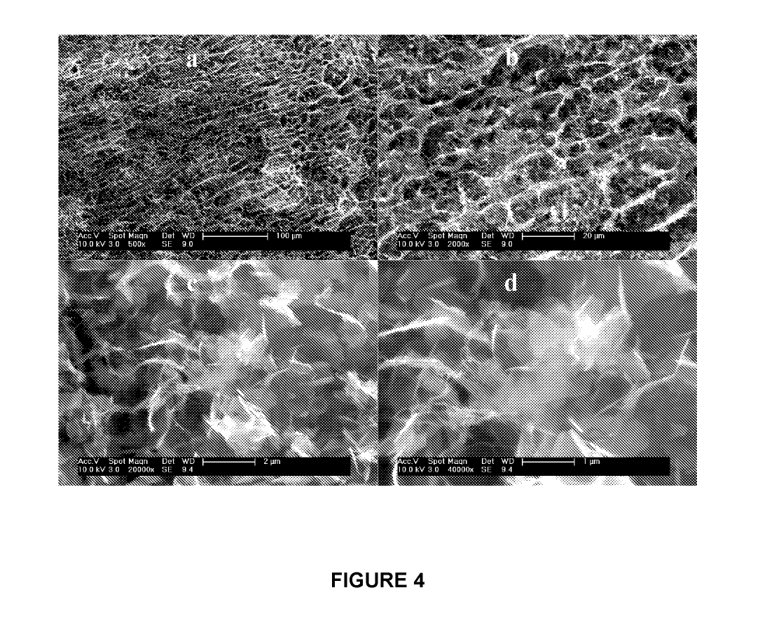

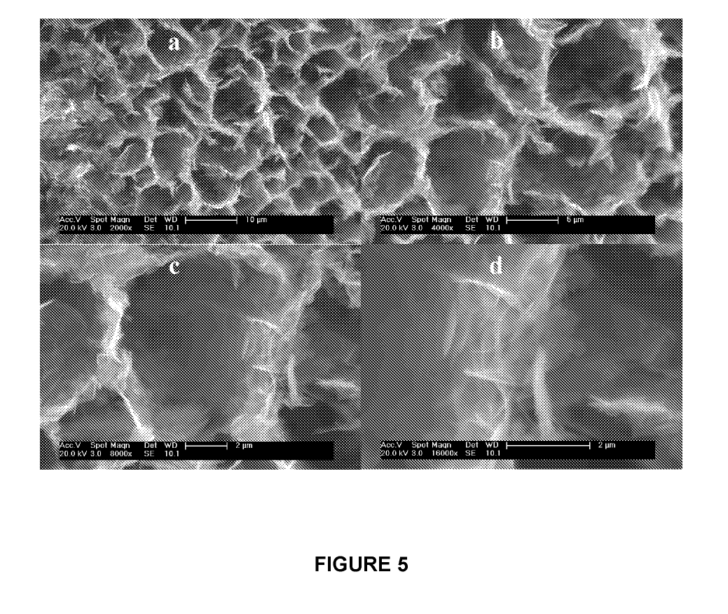

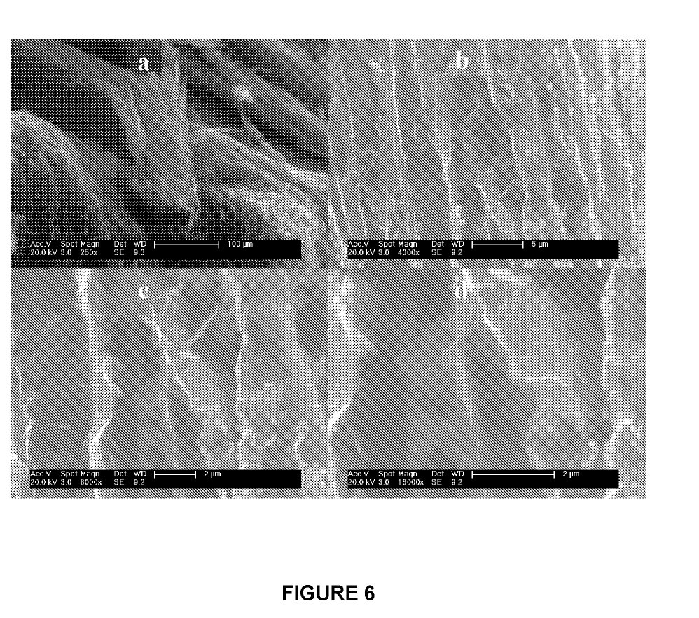

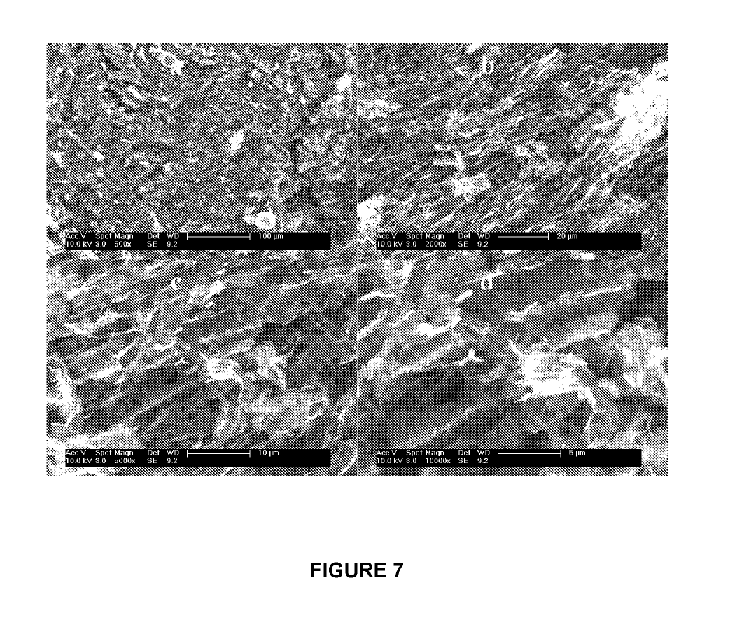

The RTFC technique provides vast flexibility in controlling the micro-architecture of graphene based aerogels (FIG. 1). The PG aerogel prepared in phenol showed a layered microstructure (FIGS. 1a & 1b). The graphene sheets were homogenously distributed in the aerogel without any aggregation (FIGS. 1c & 1d). The space between the layers can be simply modified by adjusting the density of the aerogel (FIGS. 1 & 2). The layer spaces decreased significantly when concentration increased to 40 mg/cm³. The morphology can also be engineered by choosing different base solvents. For example, when taking camphene as a base solvent, the aerogel with density of 20 mg/cm³ formed a cell microstructure with cell dimension of about 5 μm (FIG. 3). The architecture can be further modified by addition of additives, such as carbon nanotubes and polymers. For 20 wt % MWCNT/80 wt % PG aerogel (FIG. 4), the MWCNT acted as support of the network with graphene attached to it. With the incorporation of polyacrylonitrile (PAN) and poly (vinyl alcohol) (PVA), the honeycomb and folder microstructures were formed (FIGS. 5 and 6). It is remarkable that the aerogel with density as high as 100 mg/cm³ is producible by using RTFC. The 15 wt % SWCNT/85 wt % PG aerogel with density of 100 mg/cm³ showed a highly compact architecture with homogenous distribution of both graphene and SWCNT (FIG. 7). Thus, depending on applications, graphene aerogels with desired micro-architecture can be easily engineered to meet various requirements.

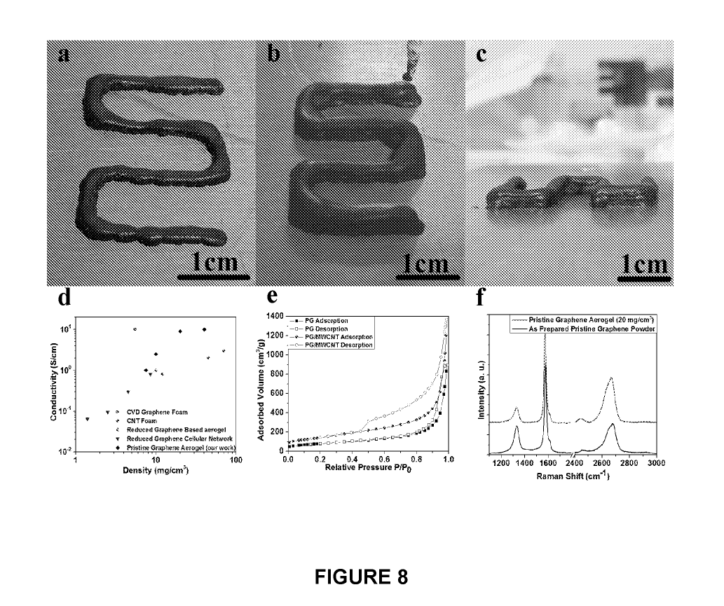

Freestanding pristine graphene piles with thickness from 1 mm to 3 mm were built in air at room temperature using robotic assisted deposition (FIGS. 8a to 8c). The sonicated mixture of PG and phenol with a concentration of 20 mg/cm³ was directly used as ink. A single deposition produced a layer with thickness about 1 mm. Thus, the deposition was repeated three times in order to produce the pile with a thickness of 3 mm (FIGS. 8b and 8c). Each deposition was carried out immediately after solidification of the previous layer at room temperature, which is highly compatible with commercial 3D printing techniques. Subsequently, the printed freestanding graphene aerogels with no shrinkage were obtained by full sublimation of phenol. FIG. 8d shows the electrical conductivity of PG aerogel as a function of density. The electrical conductivity increased dramatically with the increasing density until reaching 9 S/cm at a density of 20 mg/cm³. Although the conductivity of the pristine aerogel is not as good as CVD graphene foam in similar density, it is comparable to those of both RGO based aerogels and CNT foams, owing to superior electrical conductivity and homogenous distribution of PG in the aerogel. Surface area of the aerogels was determined by nitrogen adsorption/desorption isotherms (FIG. 8e). For the measurement, the initial concentration of both mixtures prepared was 2.5 mg/cm³. The density of graphene aerogel became 6 mg/cm³ due to shrinkage during sublimation of phenol. For graphene/MWCNT aerogel, there was no shrinkage observed. Langmuir surface area of the graphene and graphene/MWCNT aerogel is 394 m²/g and 701 m²/g, respectively (Table 1).

TABLE 1
Surface area of the aerogels calculated by various methods.

| Method | PG (m²/g) | PG/MWCNT |
|---|---|---|
| Brunauer, Emmett and | 282 | 506 |
| Teller (BET) | | |
| Langmuir | 394 | 701 |
| BJH Desorption cumulative | 326 | 813 |
| surface area of pores | | |

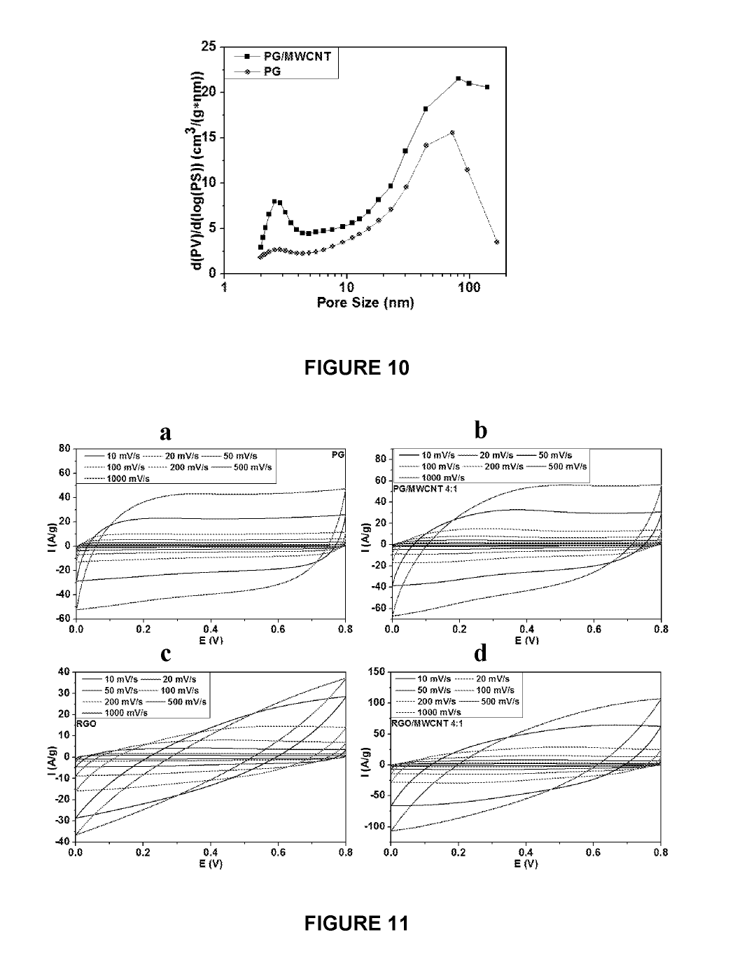

The pore size distribution determined by the Barret-Joyner-Halenda (BJH) method (FIG. 10) suggests that much of the pore volume lies in the 10-200 nm range, with a peak pore diameter of 73 nm for graphene aerogel and 83 nm for graphene/MWCNT aerogel. These observations indicate that the carbon nanotube provided structural support for the aerogel as well as preventing graphene from restacking and aggregation. Raman spectra (FIG. 8f) confirmed homogenous distribution of graphene sheets in the aerogel. The position of the 2D peak shifts from 2666 cm⁻¹ (for the as prepared PG powder) to 2656 cm⁻¹ (for the PG aerogel), and the ratio of intensity of the 2D peak to that of G peak significantly increased from 0.4 to 0.63. The shift and increasing intensity suggest that the graphene is of a better quality and has fewer layers. Thus, these observations indicate the presence of high quality graphene sheets in the aerogel without significant restacking and aggregation.

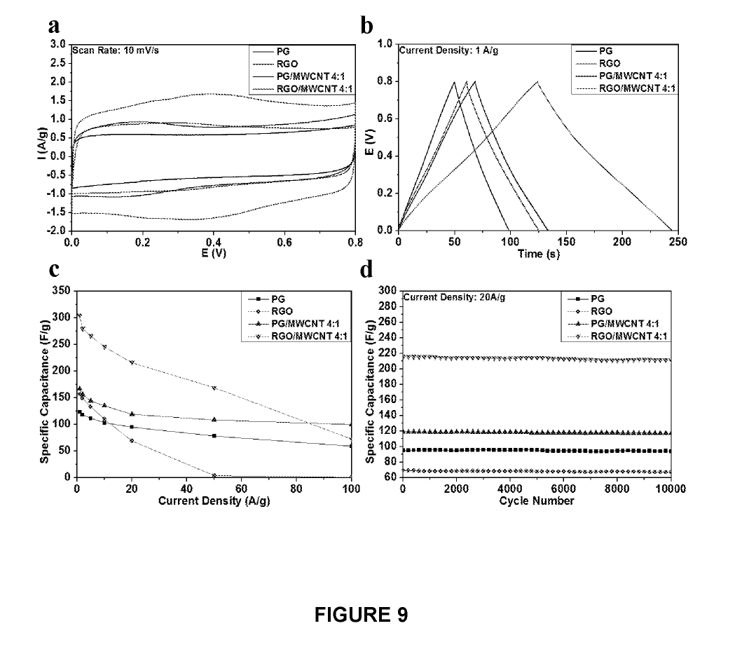

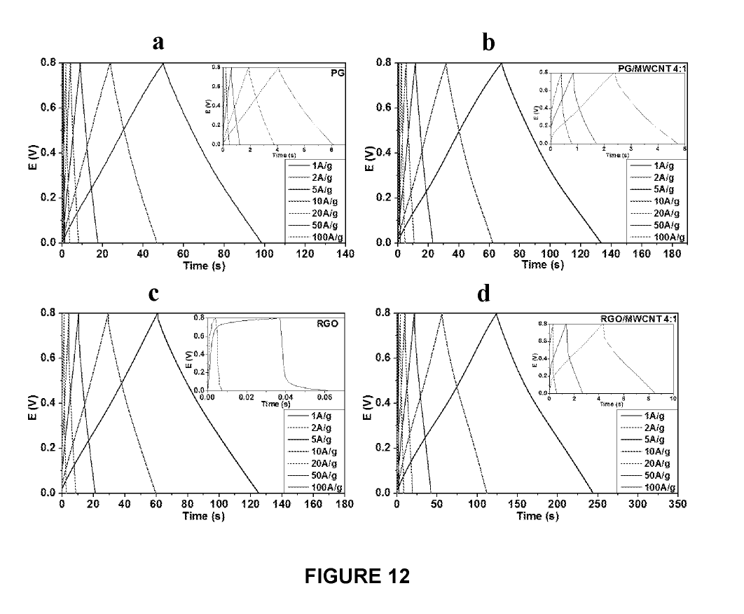

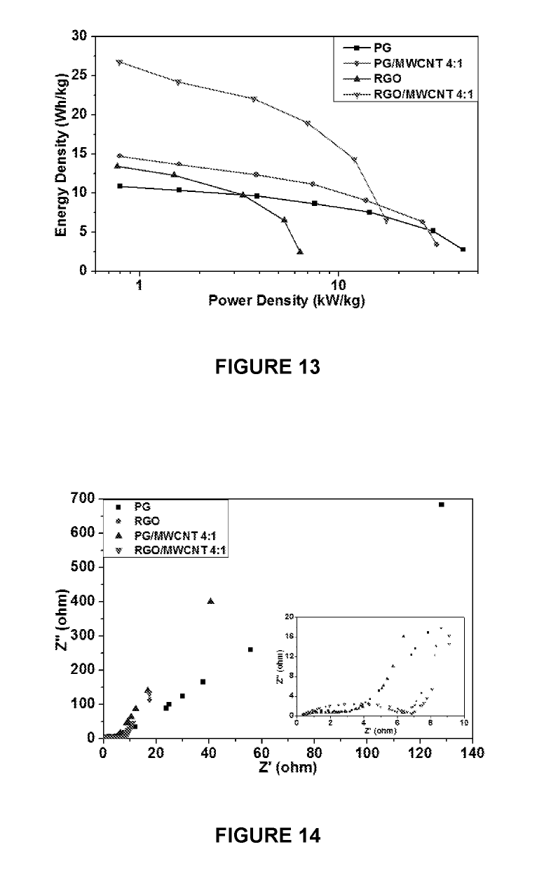

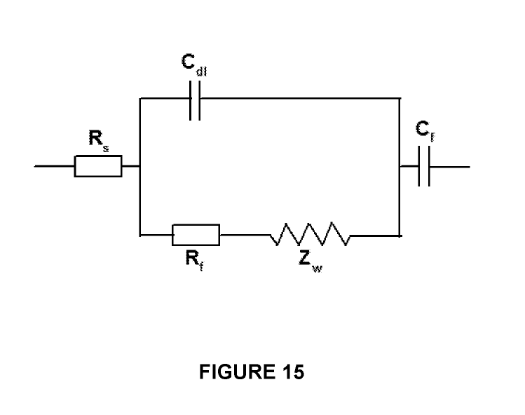

Application of the aerogels as a supercapacitor was demonstrate and the performance was measured in a two-electrode configuration (FIGS. 9, 11 & 12). Aerogel with the same mass was directly attached to the current collector without any binder to make electrode, and then two electrodes were firmly pressed with a filter paper sandwiched in between to assemble a supercapacitor cell. The CV curves of various aerogels at a scan rate of 10 mV/s are shown in FIG. 9a. The CV curves of the PG, PG/MWCNT, RGO, and RGO/MWCNT aerogels with the scan rate of 10, 20, 50, 100, 200, 500, and 1000 mV/s were shown in FIG. 11. Redox peaks were observed in the CV curves of RGO, G/MWCNT, and RGO/MWCNT due to the presence of oxygen containing group in RGO and impurities in MWCNT. PG aerogel showed no distinctive peak, which confirms its pure nature without any functionality. Furthermore, all the CV curves displayed a rectangular shape suggesting the excellent double layer capacitance characteristics. Galvanostatic cycling of the aerogels was performed at a current density of 1 A/g (FIG. 9b). The aerogels exhibited nearly ideal triangular charge/discharge curve which indicates high charge mobility at the electrodes. Galvanostatic cycling of the various aerogels was performed at the current density of 1, 2, 5, 10, 20, 50, 100 A/g (FIG. 12). The specific capacitance (SC) of PG, RGO, PG/MWCNT, and RGO/MWCNT at the current density of 1 A/g is 123 F/g, 157 F/g, 167 F/g and 305 F/g (FIG. 9c). Furthermore, the energy density of PG, RGO, PG/MWCNT, and RGO/MWCNT at the current density of 1 A/g is 10.87, 13.45, 14.73, and 26.74 Wh/kg respectively (FIG. 15). Comparing to reported data on graphene aerogels (Table 2), the aerogels prepared by simple RTFC method are among one of the highest.

TABLE 2
Comparison of measured parameters of graphene
aerogels prepared by different methods.

| | | Capacitance |
|---|---|---|
| Sample | Process | (F/g) |
| RGO/MWCNT (the | Hydrothermal reduction of graphene | 305 F/g at |
| present invention) | oxide and processing of RGO and | 1 A/g |
| | MWCNT by RTFC | |
| PG/MWCNT (the | processing of PG and MWCNT | 167 F/g at |
| present invention) | by RTFC | 1 A/g |
| Nitrogen-Doped | Hydrothermal reduction of graphene | 223 F/g at |
| Graphene Aerogels^{A} | oxide with addition of ammonia | 0.2 A/g |
| Electrochemically | Assemble of anisotropic graphene | 325 F/g at |
| Exfoliated | into a cross-linking network from | 1 A/g |
| Graphene Aerogel^{B} | their colloidal suspensions at the | |
| | transition from the semi-dilute to | |
| | the isotropic concentrated regime. | |
| Cellulose nanofibril | Freeze drying of CNF/GONS/ | 252 F/g at |
| (CNF)/reduced | CNT aqueous dispersion followed | 0.5 A/g |
| graphene oxide | by direct thermal heating reduction | |
| (RGO)/carbon | | |
| nanotube (CNT) | | |
| hybrid aerogels^{C} | | |
| Palladium (Pd) | Liquid phase mix of Pd salt and | 175.8 F/g at |
| loaded graphene | graphene oxide followed by freeze | 5 mV/s |
| aerogel^{D} | drying, hydrazine reduction and | |
| | further thermal reduction | |
| Three-Dimensional | In situ formation of precursor GO | 366 F/g at |
| Graphene Aerogel | aerogel on the nickel foam (NF) | 2 A/g |
| on Nickel Foam^{E} | followed by thermal reduction | |
| Polypyrrole- | Hydrothermal reduction of graphene | 350 F/g at |
| mediated | oxide directly with pyrrole monomer | 1.5 A/g |
| Graphene Foam^{F} | | |

A Sui, Z. Y. et al. Nitrogen-Doped Graphene Aerogels as Efficient Supercapacitor Electrodes and Gas Adsorbents. Acs Appl Mater Inter 7, 1431-1438, doi:10.1021/am5042065 (2015).
B Jung, S. M., Mafra, D. L., Lin, C. T., Jung, H. Y. & Kong, J. Controlled porous structures of graphene aerogels and their effect on supercapacitor performance. Nanoscale 7, 4386-4393, doi:10.1039/c4nr07564a (2015).
C Zheng, Q. F., Cai, Z. Y., Ma, Z. Q. & Gong, S. Q. Cellulose Nanofibril/Reduced Graphene Oxide/Carbon Nanotube Hybrid Aerogels for Highly Flexible and All-Solid-State Supercapacitors. Acs Appl Mater Inter 7, 3263-3271, doi:10.1021/am507999s (2015).
D Yu, Z. N. et al. Functionalized graphene aerogel composites for high-performance asymmetric supercapacitors. Nano Energy 11, 611-620, doi:10.1016/j.nanoen.2014.11.030 (2015).
E Ye, S. B., Feng, J. C. & Wu, P. Y. Deposition of Three-Dimensional Graphene Aerogel on Nickel Foam as a Binder-Free Supercapacitor Electrode. Acs Appl Mater Inter 5, 7122-7129, doi:10.1021/am401458x (2013).
F Zhao, Y. et al. Highly Compression-Tolerant Supercapacitor Based on Polypyrrole-mediated Graphene Foam Electrodes. Adv Mater 25, 591-595, doi:10.1002/adma.201203578 (2013).
G Fan, Z. J. et al. Asymmetric Supercapacitors Based on Graphene/MnO2 and Activated Carbon Nanofiber Electrodes with High Power and Energy Density. Adv Funct Mater 21, 2366-2375, doi:10.1002/adfm.201100058 (2011).

The SC of graphene/carbon nanotube aerogels is higher than that of graphene alone aerogels, which confirmed the structure supporting role of carbon nanotube in the aerogels. The presence of carbon nanotube also acted as separator which effectively prevents PG and RGO from restacking and aggregation, which is consistent with surface area measurement. Furthermore, the SC of the PG based aerogels is lower than that of RGO based aerogels at the current density of 1 A/g, as PG is much easier to restack than RGO due to lack of functionality, which leads to less exposed surface area. Furthermore, the residual functionality of RGO also enhanced the capacitance through introducing redox reaction. As is shown in FIG. 9c, the SC of the aerogels decreased with the increasing current density due to the IR drop induced by equivalent series resistance (ESR). The decreasing rate of PG based aerogel is much lower than that of RGO based aerogel, owing to their superior electrical properties. It is remarkable that the PG/MWCNT aerogel gave a SC of 100 F/g at a fast scan rate of 100 A/g. In addition, all the graphene aerogels exhibited excellent electrochemical stability and a high degree of reversibility (FIG. 9d). The coulombic efficiency of the initial capacitance for G, RGO, G/MWCNT, and RGO/MWCNT after 10000 cycles is 98.9%, 97.1%, 98.3%, and 97.7%. Electrochemical impedance spectroscopy (EIS) of the aerogel based supercapacitors was investigated and the results was plotted as Nyquist impedance curves (FIG. 14). The plots of the graphene based aerogels consists a small semicircle in high frequency region and a nearly vertical line in low frequency region, indicating a low electronic resistance and pristine capacitive behaviour. The diameter of semicircle in high frequency is directly corresponding to ESR of a supercapacitor. The ESR of G, G/MWCNT, RGO, and RGO/MWCNT are 2.6, 2, 5.93, and 6.51 ohm respectively. Base on ESR, the maximum powder density of the G, G/MWCNT, RGO, and RGO/MWCNT was determined to be 15.38, 20, 6.74, 6.14 kW/kg. It is clearly shown that ESR of PG based aerogels are more than 2 times smaller than that of RGO based aerogels, while the maximum powder density of PG based aerogels are over 2 times higher than that of RGO based aerogels, owing to superior electrical conductivity of PG based aerogels. The fitting parameters of EIS spectrums based on the equivalent circuit model (FIG. 15) are listed in table 3.

TABLE 3
The fitting parameters of EIS spectrums based on the equivalent circuit.

| | | | | | Z_{w} |
|---|---|---|---|---|---|
| | | | | | (1/(Ohm |
| Sample | Rₛ (ohm) | C_{dl} (F) | R_{f} (ohm) | C_{f} (F) | sqrt(Hz)) |
| PG | 2.47E−01 | 6.887E−05 | 2.08E+00 | 2.039E−02 | 5.887E−02 |
| PG/MWCNT 4:1 | 3.226E−01 | 6.329E−05 | 1.843E+00 | 4.527E−02 | 9.665E−02 |
| RGO/MWCNT 4:1 | 3.82E−01 | 6.124E−05 | 5.669E+00 | 1.299E−01 | 3.01E−01 |
| RGO | 4.104E−01 | 7.318E−05 | 5.115E+00 | 1.546E−01 | 2.976E−01 |

Comparing to RGO based aerogels, PG based aerogels showed enhanced supercapacitor performance by dramatically reduction of contact resistance at the active material/current collector interface (Rₛ), charge-transfer resistance (R_{f}), and the Warburg resistance (Z_{w}).

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### Examples

### Preparation of Graphene Sheets

Pristine graphene sheets were prepared from graphite nano-platelets (XG Sciences Ltd., xGnP M-5) using a liquid phase exfoliation method developed by Lin et al (Lin, Y., Jin, J., Kusmartsevab, O. & Song, M. Preparation of Pristine Graphene Sheets and Large-Area/Ultrathin Graphene Films for High Conducting and Transparent Applications. J. Phys. Chem. C, 117, 17237-17244 (2013)). 1 g of graphite nanoplatelets (xGnp M-5) were dispersed in 50 ml mixture of phenol and methanol (ratio: 5:1) under sonication for 30 minutes. With the addition of 100 mg cetyltrimethylammonium bromide (CTAB), the resultant suspension was sonicated for another 30 minutes, and then was left to soak for 2 days. Afterwards, the mixture was centrifuged and the collected sediment was transferred to 1000 ml mixture of water and methanol (ratio: 4:1), followed by stirring for 2 hours. Finally, the exfoliated graphene was carefully separated from the resultant graphite/graphene mixture by centrifugation. The resultant graphene was washed for three times by de-ionized water, and dried at 60° C. for further use.

### Graphene Oxide Synthesis and Reduction

Graphite oxide aqueous dispersion was prepared from natural graphite (Graphexel, 2369) following the method described elsewhere (see, for example, Xu, Y. X., Bai, H., Lu, G. W., Li, C. & Shi, G. Q. Flexible graphene films via the filtration of water-soluble noncovalent functionalized graphene sheets; J. Am. Chem. Soc., 130, 5856, (2008)). 3 g graphite powder was mixed with concentrated H₂SO₄ (12 mL), K₂S₂O₈ (2.5 g), and P₂O₅ (2.5 g) and the mixture was heated to 80° C. for 5 hours. Afterwards, the mixture was diluted with de-ionized water (0.5 L), then filtered and washed with H₂O to remove the residual acid. The resultant solid was dried at 80° C. overnight. This pre-oxidized graphite was then subjected to oxidation by Hummers' method. The pretreated graphite powder was transferred into concentrated H₂SO₄ (120 mL) cooled in an ice bath. Then, KMnO₄ (15 g) was added gradually under stirring to keep the temperature below 20° C. Successively, the mixture was stirred at 35° C. for 4 h, and carefully diluted with H₂O (250 mL). Then the mixture was stirred for 2 h at 90° C., followed by addition of H₂O (0.7 L). Shortly, H₂O₂ (30%, 20 mL) was added to the mixture, the resulting brilliant yellow mixture was filtered and washed with HCl aqueous solution (10 wt %) to remove metal ions. Finally, the graphite oxide was washed repeatedly with H₂O until it was a neutral pH, in order to remove all the acid. The resultant solid was dried and diluted to make a graphite oxide dispersion (6 mg/ml). To prepare reduced graphene oxide, the as-prepared graphite oxide dispersion was sonicated to exfoliate graphite oxide into graphene oxide and then was transferred to a sealed 50 ml Teflon-lined autoclave, following by heating up to 180° C. and kept for 12 hours. The resulting reduced graphene oxide was filtered, frozen at −50° C. for 2 h, and then was freeze-dried for 24 h for further use.

### Preparation of Aerogels

The aerogels were prepared in various concentrations (2 to 100 mg/mL) by using various carbon materials (pristine graphene, reduced graphene oxide optionally mixed with multi-walled carbon nanotube or single-walled carbon nanotube), and various solvents (phenol and camphene). Typically, 100 mg of graphene and 5 ml phenol were added into a 7 ml vessel, and the mixture was stirred at 50° C. for half hour. Afterwards, the mixture was sonicated with a power of 5 watts for 15 minutes in a 50° C. oil bath. The mixture was then solidified (frozen) in liquid nitrogen. Finally, the bulk aerogel was obtained by full sublimation of phenol or camphene from the solidified mixture in a fume hood at room temperature.

Graphene aerogels have successfully been prepared in methods similar to that described above but using the following solvents: menthol; naphthalene; 72:28 camphor:naphthalene mixture; 69:31 camphor:naphthalene mixture and 66:34 camphor:naphthalene mixture. These aerogels were prepared with a 5 mg/ml graphene concentration, were sonicated at approx. 80° C. and quenched in liquid nitrogen.

### Printing Demonstration

For printing, the sonicated mixtures prepared in the previous paragraph were transferred to a Luer Lok syringe with a smooth flow tapered nozzle (159 μm inner diameter) attached and directly used to print 3D objects using a robotic deposition device (I&J7300-LF Robotics, I&J Fisnar Inc.). During printing, the syringe was heated to 60° C. and the 3D printed structures solidified on the substrate at room temperature and were subsequently dried in a fume hood at room temperature.

### Characterization

The microstructural architecture of the graphene based aerogels were investigated by Scanning Electron Microscopy (Philips XL30 FEGSEM). The electrical conductivity of the aerogels was measured using a standard 4-point probe method by a NumetriQ PSM1735 analyzer. The densities of the aerogels were determined by measuring their dimensions using a digital caliper vernier and their mass using a balance with 0.001 mg accuracy. The nitrogen adsorption isotherm measurements were performed at −196° C. using a Micromeritics ASAP 2020 surface area and porosity analyser. The Raman spectra were taken using a Renishaw 2000 Raman spectrometer system with a HeNe laser (1.96 eV, 633 nm). For supercapacitor tests, the aerogel was directly attached to 325 mesh stainless steel gauze as working electrodes. The test was carried out in a two-electrode system. The working electrodes separated by a filter paper was firmly pressed by two poly(methyl methacrylate) (PMMA) slides to assemble a cell. The cell was then dipped in 1 M H₂SO₄ electrolyte to perform cyclic voltammetry and galvanostatic charge-discharge over the potential range of 0 to 0.8 V. Electrochemical impedance spectroscopy (EIS) was performed by an AC voltage of 0.2 V with 5 mV amplitude over a frequency range between 10 mHz and 10 kHz. All tests were carried out using an Ivium electrochemical workstation.

### Electrochemical Measurement

To prepare a two-electrode cell, the aerogel with the same mass was directly attached to the current collector without any binder to make electrode, and then two electrodes were firmly pressed by two poly(methyl methacrylate) (PMMA) slides with a filter paper sandwiched in between to assemble a supercapacitor cell.

The specific capacitance (SC, F/g) in a two-electrode configuration was calculated from the galvanostatic charge/discharge curves using the following equations:

$$SC = \frac{2 i}{( \frac{Δ U}{t} ) \times m} = \frac{2 i \times t}{Δ U \times m}$$

where, i is the current applied, t is the discharged time, ΔU is the potential voltage window of discharge process, and m is the mass of one aerogel electrode materials.

The energy density (E) and average power density (Pₐᵥ) were calculated from the galvanostatic charge/discharge curves using the following equations²:

E=A0.5×SC×V²

where, SC is the specific capacitance, and V is the discharged voltage after IR drop.

$${P}_{av} = \frac{E}{t}$$

where, E is the energy density, and t is the discharged time.

The maximum power density (Pₘₐₓ) were calculated from the galvanostatic charge/discharge curves using the following equation²:

$${P}_{ma x} = \frac{{V}^{2}}{4 RM}$$

where, V is the discharged voltage after IR drop, R is the equivalent series resistance, which is obtained from the Z′ axis intercept of the Nyquist plot, and M is the total mass of both electrode materials.

### Graphene-Polymer Composite Aerogels

Polymer (polystyrene (PS), polyvinyl alcohol (PVA), and polyacrylonitrile (PAN)) enhanced graphene aerogels were prepared under following procedure. Taking 20 wt % PVA/graphene aerogel as an example. 20 mg of polymer was dissolved in 5 ml phenol by magnetically stirring at 95° C. for 30 minutes. The solution was then cooled down to 50° C., followed by addition of 80 mg of graphene. Afterwards, the mixture was sonicated (Q700 Probe, QSonica, Newtown, Conn., USA) with a power of 5 watts for 15 minutes in a 50° C. oil bath. The mixture was then solidified in a glass mould at either ambient room temperature (20° C.), in an ice/water bath (0° C.), or cooled in liquid nitrogen (−196° C.). The solidified object was removed from the mould at room temperature. The aerogels were obtained by full sublimation of the solidified solvent in a fume hood at room temperature.

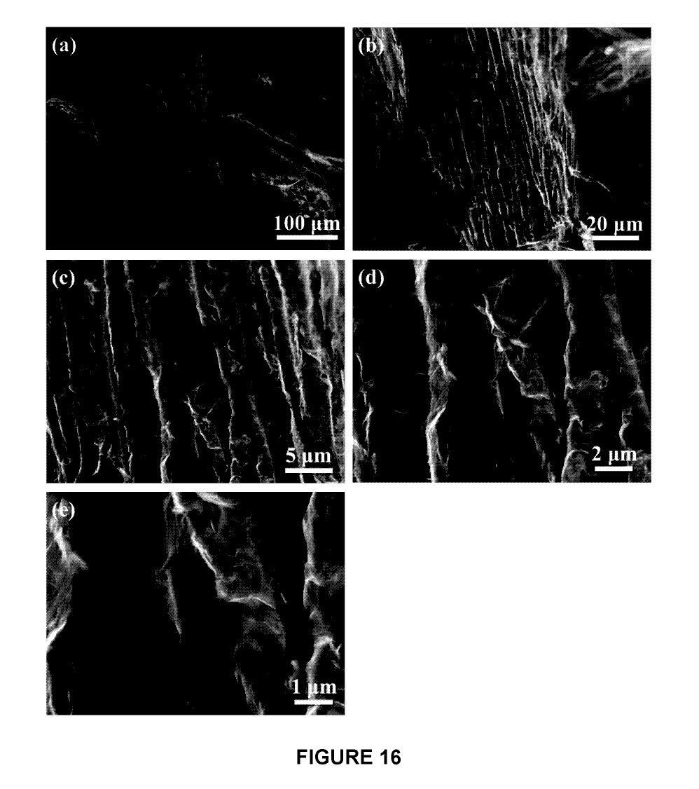

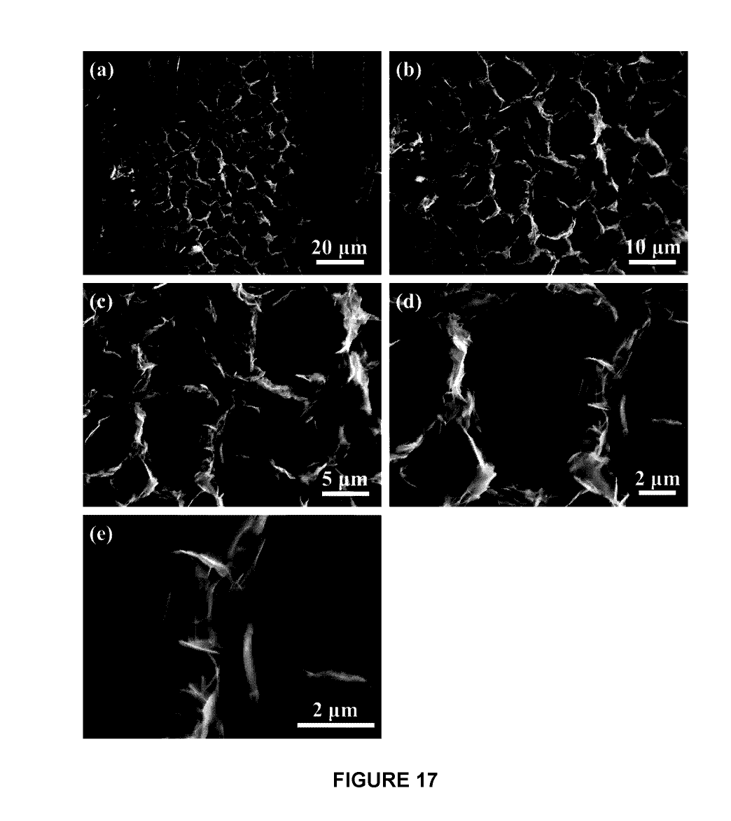

FIG. 16 shows SEM images of microstructure of the PG/PVA aerogel (weight ratio: 4:1, 40 mg/cm³) prepared in liquid nitrogen. FIG. 17 shows the SEM images of microstructure of the PG/PAN aerogel (weight ratio: 4:1, 40 mg/cm³) prepared in liquid nitrogen.

### Aerogels of Inorganic 2D Materials

To first exfoliate the bulk material (MoS₂, WS₂, MoSe₂, WSe₂, or hBN) into few layer flakes the powder is first dispersed (10 mg/ml) in a mixture of isopropanol and de-ionised water (1:1 ratio). This is then ultrasonicated at 37 KHz (40% power) at a constant temperature of 20° C. for 12 hours, before centrifuging to obtain a stable dispersion of few-layer (1-3 layers) flakes. These dispersions are then filtered to remove the flakes, which are dried. To create the aerogel the exfoliated powder is dispersed in the chosen solvent, such as phenol or menthol, at differing mass loadings. In a typical process 100 mg of exfoliated 2D material, such as MoS₂, is added to 5 ml of phenol (20 mg/ml) and stirred continually on a hot plate at 50° C. for ˜30 mins. The phenol/2D material dispersion is then bath sonicated (37 kHz, 60% power) at ˜45° C. for 10 minutes, this insures that the 2D material is homogenously dispersed throughout the solvent and the mixture remains in a liquid state. The dispersion is then poured into a glass mould and allowed to set, typically in a cold water bath (˜5° C.) for 30 min until completely solidified. The aerogel monolith is then removed from the mould and left to sublimate in a ventilated fume hood until all phenol has been removed.

This method has been used successfully to prepare the following aerogels:

MoS₂ (20 mg/mL); WS₂ (20 mg/mL), hBN (20 mg/mL), MoS₂ (5 mg/mL), MoSe₂ (5 mg/mL), WSe₂ (5 mg/mL), MoS₂/WS₂ (1:1% wt, 20 mg/ml) composite; MoS₂/WS₂ (1:1% wt, 20 mg/ml) composite containing 20 wt % PVA or PVDF; hBN (20 mg/ml) 20 wt % PVA, MoS₂/MWCNT composite (1:1% wt, 20 mg/ml), MoS₂/graphene composite (1:1% wt, 20 mg/ml)

1. A method for preparing an aerogel of a two-dimensional material; the method comprising:
a) providing a suspension of flakes of the two-dimensional material in a solvent or solvent mixture;
b) reducing the temperature of the suspension to below the melting temperature of the solvent or solvent mixture to form a solid suspension; and
c) allowing or enabling the solvent or solvent mixture to sublime from the solid suspension to provide the aerogel of a two-dimensional material;
wherein the solvent or solvent mixture has a melting point at 1 atm in the range from 20 to 300 C and a vapour pressure at 25° C. in the range from 0.0001 to 2 kPa.

2. A method of claim 1, wherein the suspension also comprises a polymer.

3. A method of claim 2, wherein the polymer is selected from: polyvinylidene fluoride (PVDF), polystyrene (PS), polyvinylalcohol (PVA), poly(methyl methacrylate) (PMMA), polypropylene (PP), polyethylene (PE), polyamide (PA, Nylon), polyacetonitrile (PAN), poly(sodium 4-styrensulfonate) (PSS).

4. A method of claim 2, wherein the polymer is present in an amount from 0.1% to 80% by volume relative to the amount of the two-dimensional material.

5. A method of claim 1, wherein the amount of the two-dimensional material in the suspension may be from 0.001 to 100 mg/mL.

6. A method of claim 1, wherein the method comprises the steps of:
adding flakes of the two-dimensional material to the solvent or solvent mixture; and
applying energy to the mixture to form the suspension of two-dimensional flakes in the solvent or solvent mixture.

7. A method of claim 1, wherein the solvent has a Hansen parameter for dispersion (δ_{D}) in the range from 15 to 25 MPam^{1/2}, a Hansen parameter for polarisation (δ_{P}) in the range from 1 to 20 MPam^{1/2} and a Hansen parameter for hydrogen bonding (δ_{H}) in the range from 0.1 to 15 MPam^{1/2}.

8. A method of claim 1, wherein the solvent or at least one component of the solvent mixture is selected from: camphene, camphor, naphthalene, succinonitrile, phenol and menthol.

9. A method of claim 1, wherein the two-dimensional materials are suspended in a mixture of two or more solvents and wherein the components of the solvent mixture are such that they undergo eutectic solidification.

10. A method of claim 1, wherein the solvent mixture in which the two-dimensional material is suspended comprises at least one low boiling point solvent.

11. A method of claim 1, wherein the method comprises the step of forming the suspension into a pattern before the temperature is reduced.

12. A method of claim 1, wherein the process comprises the step of shaping the solid suspension into a desired form before the sublimation step.

13. A method of claim 1, wherein the two-dimensional material is selected from graphene, functionalised graphene, h-BN, a transition metal dichalcogen, phosphorene and a layered group IV-group VI compound and mixtures thereof.

14. A method of claim 1, wherein the two-dimensional material is graphene.

15. A method of claim 1, wherein once formed, the aerogel is compressed to reduce its porosity.

16. A method of claim 1, wherein the suspension and the resulting aerogel comprises carbon nanotubes in addition to the two-dimensional material.

17. An aerogel of a two-dimensional material obtainable by the methods of claim 1.

18. A graphene aerogel, wherein the graphene is in the form of flakes and wherein the graphene contains less than 10 weight % oxygen and/or greater than 80% of the carbon in the graphene is sp² hybridised.

19. A graphene aerogel of claim 18, wherein the graphene aerogel also comprises a polymer

20. An aerogel of a two-dimensional material selected from a transition metal dichalcogenide and hBN.

21. The aerogel of claim 20, wherein the aerogel also comprises a second two-dimensional material selected from graphene, a transition metal dichalcogenide and hBN.

22. A product comprising an aerogel of claim 17.

23. A product of claim 22, wherein the product is an electronic device, an electrode or a device comprising said electrode.

24. A solid suspension comprising flakes of a two-dimensional material distributed throughout a solvent or solvent mixture, the solvent or solvent mixture being in solid form, wherein the solvent or solvent mixture has a melting point at 1 atm in the range from 20 to 300° C. and a vapour pressure at 25° C. in the range from 0.0001 to 2 kPa.

25. The solid suspension of claim 24, wherein the solid suspension may also comprise a polymer.

26. The solid suspension of claim 24, wherein the two-dimensional material is graphene.

27. A product comprising an aerogel of claim 18.

28. A product of claim 27, wherein the product is an electronic device, an electrode or a device comprising said electrode.

29. A product comprising an aerogel of claim 20.

30. A product of claim 29, wherein the product is an electronic device, an electrode or a device comprising said electrode.
